(19) United States
(12) Patent Application Publication
(10) Pub. No.: US 2017/0206321 A1
(43) Pub. Date: Jul. 20, 2017

(54) SYSTEMS AND METHODS FOR HEALTH INFORMATION PRESCRIPTION

(71) Applicant: General Electric Company, Schenectady, NY (US)

(72) Inventor: Lawrence Patrick O'Keefe, Seattle, WA (US)

(21) Appl. No.: 15/476,614

(22) Filed: Mar. 31, 2017

Related U.S. Application Data
(63) Continuation of application No. 14/091,881, filed on Nov. 27, 2013.

(51) Int. Cl. G06F 19/00; G06Q 10/10

(52) U.S. Cl. CPC G06F 19/322; G06F 19/3456; G06F 19/345; G06Q 10/109

(57) ABSTRACT

Certain examples provide systems, method, and computer-readable media to facilitate a health information prescription and associated interaction. An example system provides a computer system including a processor that runs computer readable instructions to generate and transmit, over a network, a health information prescription (iRx), wherein the iRx includes requirements including data type for patient data to be collected and frequency of receiving patient data; a patient application or device including a processor that runs computer readable instructions to receive a transmitted iRx from the computer system; collect patient data from a patient based on the data type requirement of the iRx; transmit the patient data over a network to the computer system at the frequency required by the iRx; wherein the computer system receives the patient data transmitted from the patient application or device; evaluates the patient data using a decision support engine to generate an appropriate action; and outputs the appropriate action.

### CROSS-REFERENCE TO RELATED APPLICATIONS

This application is a continuation of U.S. patent application Ser. No. 14/091881, filed Nov. 27, 2013, the entire disclosure of which is hereby incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

Healthcare practitioners may review medical exam results stored in information systems such as hospital information systems (HIS), radiology information systems (RIS), clinical information systems (CIS), cardiovascular information systems (CVIS, etc., and storage systems such as picture archiving and communication systems (PACS), library information systems (LIS), and electronic medical records (EMR). Information stored may include patient medication orders, medical histories, imaging data, test results, diagnosis information, management information, and/or scheduling information, for example. The healthcare practitioners may obtain the information from information systems included in the healthcare environment, such as hospitals or clinics, in which the practitioner practices (e.g., local information systems) or from information systems included in other healthcare environment(s) (e.g., foreign information system(s)).

Some healthcare facilities also maintain clinical information systems for clinical reports and other medical or administrative information. As an example, a Hospital Information System (HIS) may include a Financial Information System (FIS), a Pharmacy Information System (PIS), and/or a Radiology Information System (RIS), for example. A Radiology Information System (RIS) includes radiology information for patients examined. Radiology information may include radiology reports, messages, warnings, alerts, patient scheduling information, patient demographic data, patient tracking information, and physician and patient status monitors, as examples. A RIS may also allow order entry and tracking of images and film. A HIS may be used by any healthcare facility, such as a hospital, clinic, doctor's office, or other medical office.

Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

### SUMMARY

Certain examples provide systems, method, and computer-readable media to facilitate a health information prescription and associated interaction.

Certain examples provide a method including generating, at a health provider system, a prescription for a patient including an information component, the information component instructing monitoring of patient data at a frequency using at least one of a device and an application. The example method includes transmitting the prescription from the health provider system to a patient health record. The example method includes configuring the at least one of a device and an application for the patient according to the information component of the prescription and the patient health record. The example method includes facilitating, at the patient health record, collection of the patient data via the at least one of a device and an application. The example method includes transmitting collected patient data from the patient health record to the health provider system.

Certain examples provide a tangible computer-readable storage medium including instructions which, when executed, cause a computer to implement a method. The example method includes generating, at a health provider system, a prescription for a patient including an information component, the information component instructing monitoring of patient data at a frequency using at least one of a device and an application. The example method includes transmitting the prescription from the health provider system to a patient health record. The example method includes configuring the at least one of a device and an application for the patient according to the information component of the prescription and the patient health record. The example method includes facilitating, at the patient health record, collection of the patient data via the at least one of a device and an application. The example method includes transmitting collected patient data from the patient health record to the health provider system.

Certain examples provide a system including a processor configured to communicate information between a provider's health record for a patient and a patient health record. The example processor is to generate, at the provider's health record for the patient, a prescription for the patient including an information component, the information component instructing monitoring of patient data at a frequency using at least one of a device and an application. The example processor is to transmit the prescription from the provider's health record for the patient to a patient's health record. The example processor is to configure the at least one of a device and an application for the patient according to the information component of the prescription and the patient's health record. The example processor is to facilitate, at the patient's health record, collection of the patient data via the at least one of a device and an application. The example processor is to transmit collected patient data from the patient's health record to the provider's health record for the patient.

### BRIEF DESCRIPTION OF SEVERAL VIEWS OF THE DRAWINGS

FIG. 1 illustrates an example Heath Information Prescription (iRx) system.

FIG. 2 illustrates a high level architecture and components of an example health information prescription system.

FIG. 3 depicts an example analytics dashboard associated with a Patient Data Prescription.

FIG. 4 illustrates a flow diagram of an example method to manage a patient health information prescription in conjunction with a patient health record and a provider electronic medical/health record.

FIG. 5 is a block diagram of an example processor platform capable of executing the instructions of FIG. 4 to implement the example systems and/or dashboard interface of FIGS. 1-3.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Chronic condition management often occurs outside of a physician office visit by a patient. Certain examples help a patient to track at least one physiological parameter, document it, and self report the collected data to a health provider in a way that is aligned with their plan of care. A physician can write an informational prescription through his or her health record system to dictate collection of data, as he or she might write a prescription for a medication to be ordered and taken by the patient at a prescribed dosage and frequency. The informational prescription can include a device to allow the patient to monitor the prescribed data. Data can be collected and sent back to a provider system, for example.

Certain examples provide a “health information prescription” (iRx). An iRx is a process by which a healthcare provider organization and its patients can easily communicate about patient-provided data. A healthcare information prescription is a plan of care initiated by medical provider (e.g. a physician) for a patient to provide information about a specific medical condition, and a mechanism for the patient-provided information to be collected from a mobile device, stored in a personal health record (PHR), transferred automatically back to the provider's electronic health record (EHR) system, and processed by decision support mechanisms to determine appropriate actions based on the submitted data. For example, a physician seeing a patient for hypertension might prescribe the collection of blood pressure data on a regular schedule in addition to a medication for control of blood pressure.

The iRx prescription configures the EHR to allow the receipt of the specified data at the specified frequency, in a “patient-submitted” portion of the record, which can be separate (and in many cases is separate or at least marked differently) from physician and/or other provider-entered data for the patient. The iRx prepares the interface to receive data from the personal health record portal and sends a message to the portal defining the data type and frequency to send. The patient can record the data using a mobile device, such as a blood pressure monitor, and upload the data to the personal health record portal. The PHR then sends the data via the interface to the EHR at the defined intervals.

Upon receipt of data from the PHR, the EHR saves the data to the patient-submitted portion of the record and invokes a decision support engine to evaluate the data and take appropriate action. If the values are within normal ranges (e.g., as defined by the provider), the EHR sends back an acknowledgement to the patient via the interface to the PHR. This message also contains other information to help the patient manage his or her condition (e.g., links to educational materials. If the values are outside of normal limits, an alert can be sent to the care management team, an appointment can be automatically scheduled, and/or other user-defined action(s) can be executed.

In certain examples, a Health Information Prescription (iRx) is a combination of technology components and process flow that allow digital exchange of health information between patients and providers, focused on exchange of data from mobile enabled devices and applications. In certain examples, the iRx can be used to provide instructions and/or other requests for information/data gathering in conjunction with one or more medical information systems.

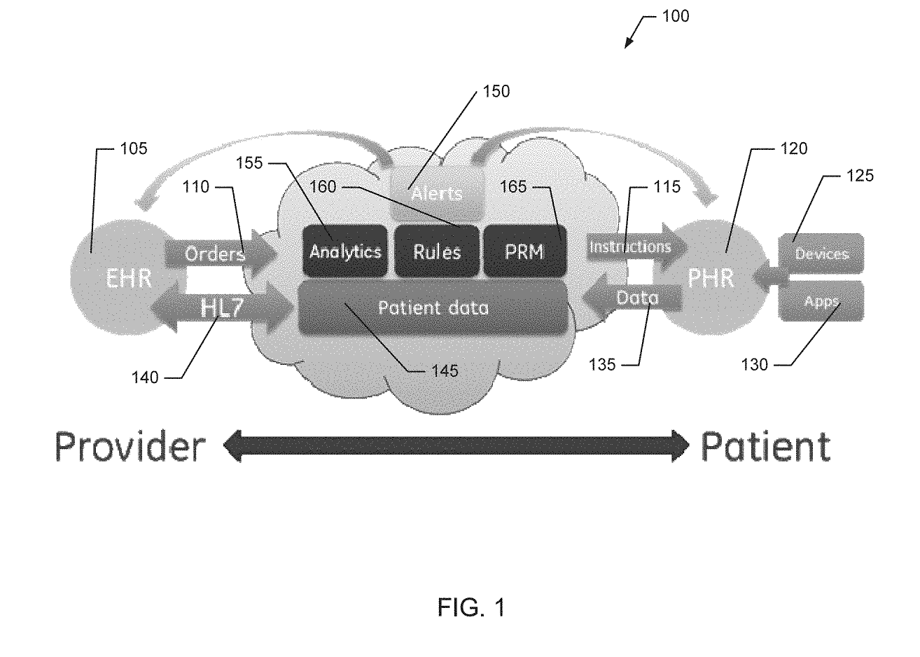

An example iRx system 100 is shown in FIG. 1. Taken from a process and data flow perspective, the Health Information Prescription (iRx) begins within an EHR, for example. The iRx includes one or more orders for specific pieces of information/data to be submitted by the patient at a specific frequency. As with an order for a laboratory test or a prescription for a pharmaceutical, the iRx sets forth a request for a product and/or service to be provided. However, with the iRx, the patient, rather than a laboratory service, is to supply the results to be incorporated into the patient record. The order itself cannot come from any EHR, and is within the current capabilities of GE's Centricity Enterprise® and Centricity Practice Solutions® products, for example.

An order (e.g., a prescription for information) flows to a component via a standard HL7 interface, for example. The order includes a patient demographic interface and triggers setup of data items that correspond to information requested in the order (e.g., systolic and diastolic blood pressure). Information about the order is transmitted to the patient via a Personal Health Record (PHR). The information can be thought of as a label for the prescription, instructing the patient on how to, and how often to, measure his or her blood pressure, blood sugar, heart rate, etc., for example.

FIG. 1 illustrates an example Heath Information Prescription system 100. As demonstrated in the example of FIG. 1, a component of an order 110 from an EHR 105 triggers acquisition of a monitoring device 125 and/or application 130 and integration with a PHR 120 based on instructions 115 provided based on the order 110. In certain examples, a provider may supply, for example, a wireless blood pressure monitor to a patient as if the monitor were any other piece of durable medical equipment. Thus, the system 100 can facilitate provisioning and patient training via a prescribed wireless device 125 and/or application 130.

Once the patient has the device 125 connected to his or her PHR 120 and has received the iRx label, the patient records requested data (e.g. blood pressure) in the PHR 120 and submits the recorded data 135 on a prescribed basis (e.g., according to a frequency prescribed in the iRx monitoring prescription). The data 135 is then transported from the PHR 120 to the EHR 105 database (e.g., as patient data 145 provided via one or more HL7 messages 140 to the EHR 105 in the example of FIG. 1). Once there, a rules engine acts on the data according to one or more rules 160, such as by checking the values submitted to determine whether the values fall into defined normal ranges. If so, an acknowledgement and potential customized message is sent back to the patient via the PHR 120 indicating that the data was received, etc. If the data falls outside of the defined limits, the system 100 generates alerts 150 that can be sent to the patient (to schedule a follow-up visit, for example), to a member of a provider's care team (to allow them to take an appropriate action, for example), etc. via a patient relationship management (PRM) module 165. Analytics 155 can also be performed based on the data and associated analysis. In certain examples, the rules 160 includes an ability to determine cases when the patient is not providing data at a prescribed frequency and can trigger automated reminders to patient and/or provider.

As illustrated in the example of FIG. 1, data 135 feedback is provided, at a frequency determined by the information prescription, from the PHR 120 into the EHR 105 from one or more devices 125 and/or applications 130 used to monitor and/or otherwise gather information from and/or related to the patient. For example, the EHR can be configured to access an identified “patient supplied” portion of a patient's electronic medical record to distinguish the patient-supplied information from observations made by a provider's staff.

On the patient's next visit, the provider can then review the patient-provided data with the patient, and the EHR 105 sends a summary of care document for the patient to view in his or her PHR 120, closing the loop for the patient-supplied data.

As shown in the example of FIG. 1, Patient Relationship Management 165 facilitate management of demographic information, preferred contact methods, alternate or additional care givers, etc. The analytics 155 allows a healthcare organization to evaluate effectiveness of an engagement with the patient and outcome(s), such as in terms of improving healthcare and reducing costs, for example.

Thus, certain examples allow physicians to request and patients to provide health data from mobile devices and/or applications into the physician's EHR 105. Certain examples facilitate a “round trip” of information between the provider and patient through both provider and patient workflows. Certain examples allow a physician to create an order for patient information that can be sent from the EHR 105 to the PHR 120 via the system 100. Certain examples allow a patient to view a label associated with an iRx and know exactly what data the physician would like them to provide, and at what frequency.

Certain examples provide embedded decision support and rules engine 160 to allow automated monitoring of data coming in to the system 100 (e.g., to the EHR 105 and/or the PHR 120) and to take different actions based on expected versus observed values (e.g., including when patient data are expected but not submitted). Certain examples provide embedded patient relationship management 165 that makes for a seamless integration between the patient's medical record in the EHR 105 and the patient's account on the PHR 120. The patient relationship manager 165 also handles communication preferences and others that can be authorized to view data on the patient's behalf.

Certain examples provide embedded analytics 155 that can be tailored to the patient to show progress on monitoring their health status. Alternatively or additionally, embedded analytics 155 can give providers a dashboard view into how their populations of patients are doing with respect to providing data and self-managing their conditions.

Certain examples provide users with an ability to send discrete patient data to EHR systems 105 using standard HL7 interfaces 140, and to segregate and mark the data clearly as patient supplied. Certain examples provide an ability to receive summary of care documents 110, 115 from the EHR 105 using standard protocols and send them to the patient's PHR 120.

Certain examples allow a physician to prescribe self-monitoring to a patient for data that will improve the physician's ability to manage the patient's medical care without additional work. Certain examples enable a patient to self-monitor his or her health and/or medical conditions using a wide variety of consumer facing health applications and devices and send the data to a provider for inclusion in the patient's medical record, thereby guiding their own medical care.

Certain examples enable Accountable Care Organizations (ACOs) with an ability to engage patients in the process of maintaining their health and wellness. Patient engagement can positively impact in at least the following areas: lower costs (e.g., fewer diagnostic testing expenditures; fewer referrals, patients less likely to choose elective surgery; reduced malpractice claims; increased adherence to medical treatment; increased health behavior changes, which leads to lower costs), better health outcomes (e.g., reduced pain and discomfort, faster recovery in physical health, improvements in emotional health; increased health behavior changes, which leads to better outcomes), better patient experience (e.g., increased patient knowledge and understanding; increased patient self-efficacy; higher patient satisfaction), etc.

Certain examples provide an enhanced ability of health care providers and ACOs to retain patients. Current providers are under threat from new, disruptive models of healthcare delivery that exploit digital technologies to make it easy for patients to utilize their services. Certain examples can help traditional providers keep pace with the changes in the marketplace. Additionally, certain examples help achieve proposed Meaningful Use Stage 3 requirements for incorporating patient supplied data in the EHR 104.

In certain examples, the system 100 can be built within the EHR 105. In certain examples, communication of iRx prescription information between the EHR 105 and the PHR 120 may or may not occur via standards-based communication protocols and data formats. In certain examples, voice-based data acquisition (e.g., patient says what his or her blood pressure is) can be used instead of or in addition to device-based or application-based data acquisition. In certain examples, rather than using the EHR 105, a web portal can be used to integrate acquired patient data apart from the EHR 105. In certain examples, such integration of data can be built into the device and/or application used to collect the patient data.

In operation, for example, the system 100 helps a clinician write an iRx, also referred to as an integrated care patient data prescription (PDRx) from within his or her EHR or EMR 105. The patient receiving the prescription provides data via one or more devices 125 and/or applications 130 associated with the prescription and is more connected with the clinician, who then has a better, more up-to-date sense of how the patient is doing. For example, a provider wants to know how his or her hypertensive patients are complying with their plan of care in between office visits.

Using the example system 100, the medical provider (e.g., a physician) initiates a care plan via the EHR 105 for a patient to provide information about a specific medical condition (e.g., hypertension). The request for information is represented by an order 110 or an order set within the provider EHR 105. Associated with the order 110, a device 125 and/or application 130 is ordered (e.g., prescribed) for self-collection of patient data by the patient. Instructions 115 are delivered to the patient via the patient's PHR 120 regarding collection and transmission of information with the prescribed device(s) 125 and/or application(s) 130. Data from device(s) 125 and/or application(s) 130 is captured and transmitted to the PHR 120. The data 135 is then transferred from the PHR 120 into a data store, such as a cloud-based data store (e.g., as patient data 145). The patient data 145 is transmitted to the EHR 105 via one or more data messages 140 (e.g., HL7 messages) on a frequency or rhythm specified in the prescription.

For example, if a patient is visiting his or her doctor for an annual checkup and the patient is diagnosed with mild hypertension, the provider can generate an order 110 including Lisinopril for blood pressure (BP) control and a patient data prescription (PDRx) for patient self-monitoring of BP (e.g., an instruction to measure BP once per week). The PDRx is sent from the EHR 105 to the PHR 120 via the system 100.

The PDRx order 110 is received by the cloud- and/or other server-based solution shown in the example of FIG. 1. A care team member with the provider can fulfill the PDRx order to provide the patient with a BP monitoring device 125, initiate a monitoring account, and configure a monitoring application (e.g., Web, smartphone, etc.), for example. The care team works with the patient to set up the monitoring solution, either directly or through a third party, for example. The patient authorizes provider access to some or all personal data via the monitoring account, for example.

The patient takes his or her blood pressure at home using the prescribed device 125. The patient's monitoring account receives the patient data (e.g., via a smartphone application). Data can then be transmitted (e.g., automatically) from the account to the patient's PHR 120. In certain examples, an email and/or other message is sent to the patient and/or provider confirming receipt of the monitoring data at the PHR 120. The monitoring application can include a calendar and/or other reminder application to guide monitoring according to provider instruction (e.g., once per week). The data 145 can be stored until a next scheduled push to the EHR 105, for example.

Data 145 can then be pushed to the EHR 105 via a standards-based interface 140 at a frequency governed by the PDRx, for example. The data 145 is received as “patient submitted data”, for example. The provider can then review the data with the patient at the patient's next appointment with the provider.

In certain examples, automatic reminder messages can be sent to the patient if the patient fails to take a reading within a specified time frame. In certain examples, alerts can be sent to the patient and/or care team when a range has been broken that involves more attention. Provider-facing reports and analytics 155 and/or consumer-facing analytics 155 can be pushed to the EHR 105, delivered on a local application, etc.

In certain examples, cloud-based rules 150 and/or other decision support can help determine appropriate workflow action(s) based on submitted patient data. Rules 150 can check collected monitoring data against a defined range, threshold, etc. If the data 135 is within range, then receipt of data can be acknowledged to the patient. If the data 135 is out of range, then the patient's care team can be notified, and the patient can also be notified for an appropriate next action (e.g., increase reporting frequency, educational material push, call office to schedule an appointment, etc.).

In certain examples, a cloud-based analytic and reporting platform 155 includes a consumer-facing reporting and trending tool for patients to self-manage her or her team. The analytic and reporting platform 155 also includes provider-oriented reporting and analytics that help manage patient outcomes.

In certain examples, a patient relationship management application stored patient information including device information, scheduled appointments, upcoming clinical reminders, educational materials, family relationship proxies, etc. The EHR 105 can automatically send a summary of care document out to the PHR 120 following a clinical encounter.

Thus, certain examples provide building blocks for patient engagement. An iRx order, prescribed device and integration, PHR, and EHR combination establishes a connection between a patient and his or her provider. Rules and alerts leverage these items/information in a “low touch” way. Provider and consumer analytics are provided to convert data to information for patient care. Patient relationship management enhances the provider-patient relationship to provide patient-centered care via an EHR—PHR data exchange loop. Improved patient engagement can be facilitated through blood pressure monitoring, chronic disease monitoring, care management, health management, and patient improvement consortium.

In certain examples, provider and/or patient can be provided with an interface including a list of outstanding orders/prescriptions, order edits (e.g., for physicians), patient problems, etc. Each order can include one or more tasks including a task to set up a device and/or account for the patient to be monitored, a task providing a monitoring device, placeholders for data to be provided via an interface, etc.

Using a patient data prescription, a provider can specify resources and associated protocols/instructions to guide the patient and monitor the patient's adherence to his or her plan of care between office visits. The prescription and associated system (e.g., the system 100) documents and monitors adherence by creating a round trip flow of data, initiated by the provider writing an order 110 in the EHR 105, the patient collecting data 135 from a consumer-grade device 125, and the data 145 flowing seamlessly back to the EHR 105.

Using round trip PHR-EHR updating makes it easy or low-touch to gather these data for large populations of patients. By detecting whether or not patients are actually providing data and whether or not the data fall within normal ranges, the overhead or effort involved to manage data from thousands of patients can be greatly reduced.

Further, certain examples provide a high automation, low effort solution to facilitate automatic acknowledgement of receipt of data from a patient, automatic alerting in case of absence of data, automatic alerting in case of data exceeding defined ranges, automatic alerting in cases of data “trending high”, etc. Automated alerting allows providers to make early interventions and potentially avoid costly hospitalizations or emergency department (ED) visits. Certain examples are highly configurable to support rules for different conditions, patient populations, etc.

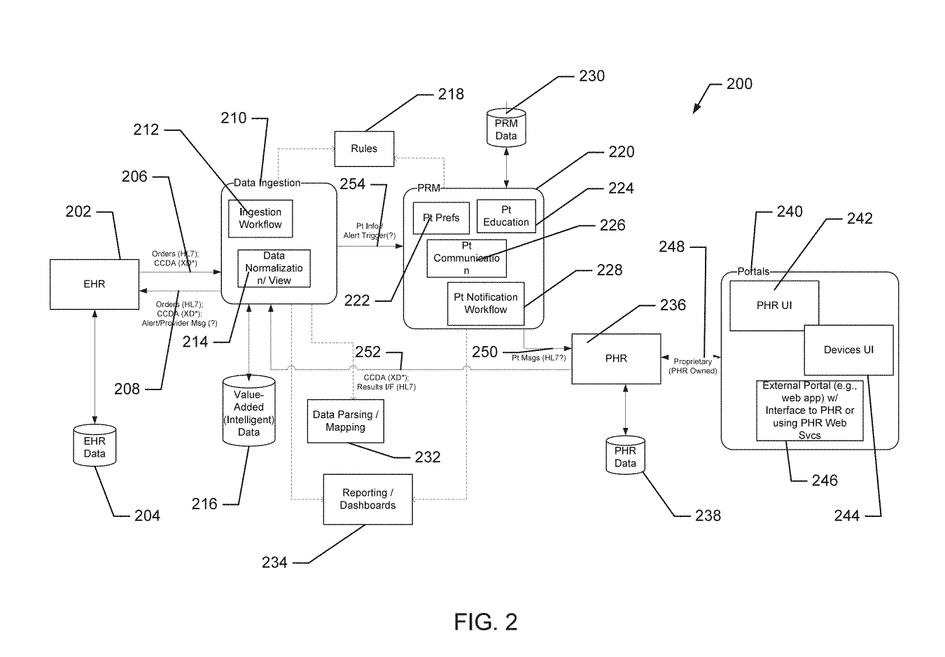

FIG. 2 illustrates a high level architecture and components of an example health information prescription system 200. The example system 200 includes an EHR 202 and associated EHR data 204. A data order (e.g., a health information prescription) and/or document 206 is transmitted from the EHR 202 to a data ingestion module 210. Thus, a provider can “order” patient-submitted data from its EHR system 202 in the same way they might order a medication, laboratory test, etc. This facilitates an engagement of the patient with his or her provider to execute a plan of care.

The data ingestion module 210 receives the order 206 and provides a data ingestion workflow 212 and data normalization/view 214 to act upon and/or otherwise process the order 206 for patient-supplied information. Data ingestion 210 works to provide and/or update value-added (e.g., intelligent) data 216, rules 218, etc. Data ingestion 210 can also provide output for data parsing and/or mapping 232 as well as visualization via one or more reporting/dashboards 234, for example.

The data ingestion module 210 also provide patient information 254 to a patient relationship management module (PRM) 220. Patient information can include and/or be replaced by an alert trigger 254 for the PRM 220, for example. The PRM 220 provides patient preferences 222, patient education 224, patient communication 226, and a patient notification workflow 228, for example. The PRM 220 provides and/or updates associated PRM data 230, for example.

Based on received patient information and/or trigger 254, the PRM 220 can generate one or more patient messages (e.g., HL7 messages) to a PHR 236. The PRM 220 can also update rules 218 alone or in conjunction with the data ingestion module 210. The PRM 220 can further provide information to the reporting/dashboard module 234, for example.

The PHR 236 receives patient message 250 from the PRM 220 and updates and/or retrieves associated PHR data 238. The PHR 236 can communication with and provide access via one or more portals 240. For example, portals 240 provide a PHR user interface (UI) 242, a devices user interface 244, an external portal 246 (e.g., a Web-based application with an interface into the PHR 236 and/or using PHR Web Services), etc. Via the portal(s) 240, one or more users, devices, and/or applications can communicate with the PHR 236 to input and/or retrieve PHR data 238.

Using a decision support and/or rules engine provided by one or more of the EHR 202, PRM 220, and PHR 236, the system 200 is configured to monitor incoming patient data and to take action on the incoming patient data based on values received and specific configuration information for a user (e.g., a provider). The incoming patient data may be provided to the PHR 236 in response to a healthcare information prescription provided from the EHR 202, for example. In certain examples, data ingestion of result data (e.g., patient-monitoring device and/or application data related to a patient) from the PHR 236 may involve additional information from the PRM 220, which can be facilitated by a dialog or exchange of messages between the PRM 220 and data ingestion 210. Data ingestion 210 can provide one or more orders (e.g., HL7), documentation (e.g., CCDA documents), alerts, and/or provider messages 208 to the EHR 202 for storage, for example.

Thus, certain examples allow a healthcare provider user to “order” patient-submitted data from their EHR system in the same way they might order a medication or a laboratory test. This facilitates the engagement of the patient with their provider on executing their plan of care. Certain examples provide decision support through a decision support and/or rules engine configured to monitor incoming patient data and to take action on the data based on values received and specific configuration information by the customer.

For example, a provider “writes” a patient data prescription, which includes a request or instruction for blood pressure measurement. The iRx prescription issues a wireless blood pressure monitor to the patient, and the system 200 helps to set up and link a personal health record for the patient to an electronic health record for the patient. If the patient has not submitted the requested data in a specified period of time, system 200 can send an alert to the patient asking him or her to submit data or, alternatively or in addition, inquiring if help is needed/wanted. In certain examples, the system 200 sends an alert to a member of a care team indicating that the patient needs/wants some follow up.

Another example facilitates actions to be taken if a blood pressure value received from a patient falls outside a normal range. In this case, an alert can be sent to a member of an associated care team indicating a high (e.g., blood pressure) value. Alternatively or in addition, a trend of blood pressure readings can be monitored, and an alert can be sent according to a threshold (e.g., if the last three values were over a criterion value and increasing).

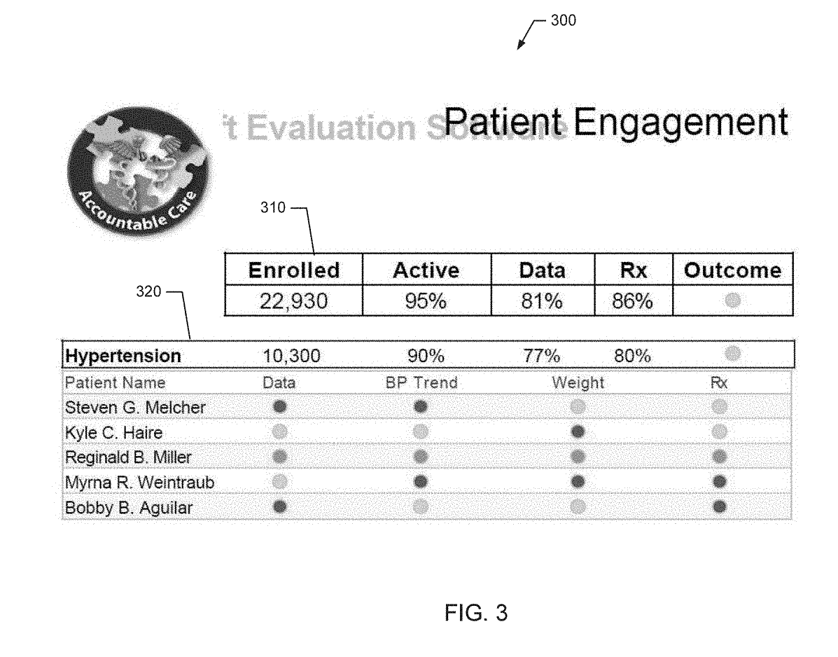

FIG. 3 depicts an example analytics dashboard 300 associated with a Patient Data Prescription. The dashboard tool 300 allows a care manager to review populations of patients that are sharing self-reported monitoring data with their providers via a PHR-EHR loop system, such as examples systems 100 and/or 200.

The example dashboard 300 provides a unified view at a level of a provider organization regarding what groups of patients are submitting data, organized by specific condition. For example, an organization may have hypertensive patients self-monitoring blood pressure. The dashboard 300 indicates how many patients are in the hypertension monitoring group, how many are actively submitting data, and how many have their blood pressure under control, for example.

In some examples, many different groups (e.g., hypertension, diabetes, asthma, etc.) can be represented in the dashboard 300. The dashboard 300 can represent an overall status using simple visuals along with an ability to drill down into per-patient specifics. In certain examples, patient-specific data can be linked to clinical outcomes (e.g., ED visits avoided) and/or cost of care (e.g., how much money is our organization spending in managing hypertensive patients compared to some norm). Information provided via and/or otherwise displayed by the dashboard 300 can be based on patient submitted data consolidated in a Personal Health Record, for example. The data is pulled into a system (e.g., a cloud- and/or other server-based system) including a database, a rules engine, and a set of analytics tools.

The example dashboard 300 shows, at a glance, how well an organization's patient engagement initiatives are doing. In the illustration of FIG. 3, a patient summary 310 shows that 22,930 patients are engaged in some type of monitoring program, 95% of them are Active (e.g., have an account created), 81% of them are submitting Data at the desired frequency, 86% have an effective treatment (e.g., their measurements are within the desired range), and that the program overall is doing well (e.g., a green circle). In the example of FIG. 3, a detail area 320 shows that, for the particular case of hypertension, 10,300 Patients are enrolled in a hypertension monitoring program. For each of the patients, based on an indicator such as a colored or shaded circle (e.g., red, green, yellow, etc.), a reviewer can see whether or not the patient is submitting data, what the patient's blood pressure and weight trends look like, and whether the patient is being effectively treated, for example.

Thus, certain examples help healthcare providers activate patients into participating in their own plans of care. For example, hypertensive patients should to adhere to a medication regime, may need to alter their diet, and, relevant here, monitor their own blood pressure between office visits. Certain examples allow self-monitored blood pressure data to be shared with a patient's provider. The care plan adherence dashboard 300 gives an organization's care manager a view to how well the organization is doing in engaging their patients with various conditions for which they are reporting data.

Certain examples provide a one-stop view of an organization's patient care plan adherence data. Certain examples provide an ability to learn what interventions are effective for different populations of patients. Certain examples provide an ability to drill down into individual patient data. Certain examples provide an improved ability for customers to control their cost of care by being able to intervene early and avoid hospitalizations or ED visits. Certain examples help facilitate improved patient compliance with plans of care.

While example implementations are disclosed and described above with respect to FIGS. 1-3, one or more of the elements, processes and/or devices illustrated in FIGS. 1-3 may be combined, divided, re-arranged, omitted, eliminated and/or implemented in any other way. Further, one or more elements of systems 100 and/or 200 and dashboard 300 may be implemented by hardware, software, firmware and/or any combination of hardware, software and/or firmware. Thus, for example, any of the example elements shown in FIGS. 1-3 can be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example components is/are hereby expressly defined to include a tangible computer readable storage device or storage disk such as a memory, a digital versatile disk (DVD), a compact disk (CD), a Blu-ray disk, etc. storing the software and/or firmware. Further still, the example systems 100, 200 and dashboard 300 may include one or more elements, processes and/or devices in addition to, or instead of, those illustrated in FIGS. 1-3, and/or may include more than one of any or all of the illustrated elements, processes and devices.

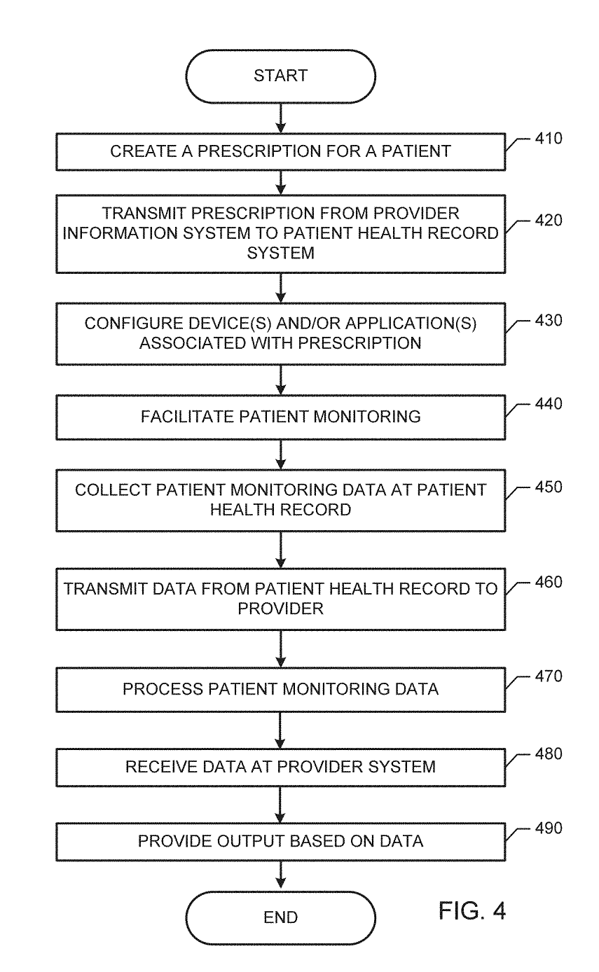

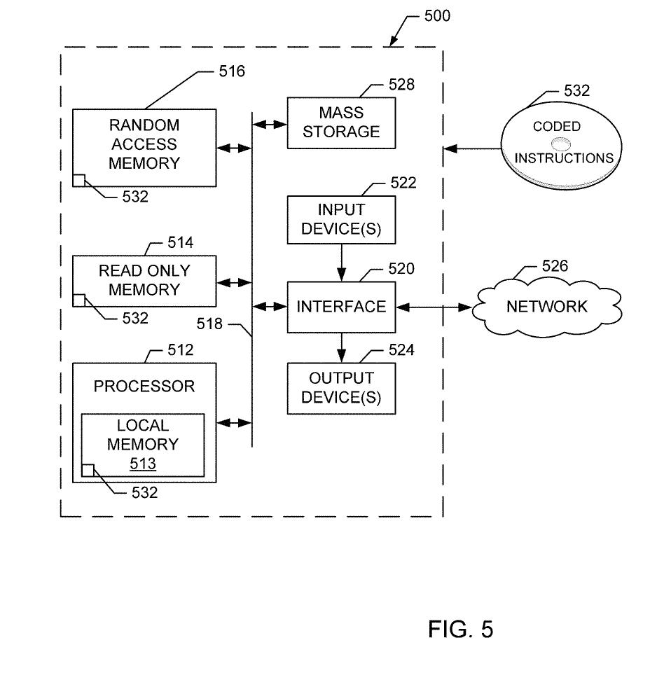

A flowchart representative of example machine readable instructions for implementing the example systems and interfaces disclosed and described herein is shown in FIG. 4. In this example, the machine readable instructions include a program for execution by a processor such as the processor 512 shown in the example processor platform 500 discussed below in connection with FIG. 5. The program may be embodied in software stored on a tangible computer readable storage medium such as a CD-ROM, a floppy disk, a hard drive, a digital versatile disk (DVD), a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowchart illustrated in FIG. 4, many other methods of implementing the example systems, dashboards, etc., may alternatively be used. For example, the order of execution of the blocks may be changed, and/or some of the blocks described may be changed, eliminated, or combined.

As mentioned above, the example process(es) of FIG. 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example process(es) of FIG. 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

Although the following examples are described in conjunction with the example systems 100, 200 and dashboard interface 300 of FIGS. 1-3, the example method 400 may be used in conjunction with other information systems. FIG. 4 illustrates a flow diagram of an example method 400 to manage a patient health information prescription in conjunction with a patient health record and a provider electronic medical/health record.

At block 410, a healthcare provider creates a prescription for a patient. The prescription includes an information component. The information component specifies a measurement to be collected by the patient and a device and/or application to facilitate that collection, for example. For example, a doctor prescribes a patient with a continuous glucose monitor to monitor his or her blood sugar levels several times a day for a period of two weeks. The prescription is entered via the provider's clinical information system such as an EHR and/or EMR.

At block 420, the prescription is transmitted from the provider's clinical information system to the patient's PHR. For example, the prescription is routed as one or more orders via a cloud- and/or other server-based platform or infrastructure that can track, record, analyze, and/or otherwise apply rules to the order before it reaches the PHR.

At block 430, one or more devices and/or applications associated with the information component of the prescription are configured for the patient based on the prescription. For example, the glucose monitor and associated monitoring application are configured for the patient based on the data prescription instructing the collection of blood sugar data.

At block 440, patient monitoring is facilitated. For example, the patient can be prompted to check his or her blood glucose via the device and/or associated application. Alternatively or in addition, the device can be controlled to automatically take blood sugar readings from the patient and to notify the patient of the reading, for example.

At block 450, patient monitoring data is collected from the device and/or application at the PHR. For example, blood sugar data is sent from the device and/or associated monitoring application to the patient's PHR for storage and/or analysis.

At block 460, the patient monitoring data is sent from the patient's PHR to the provider's information system (e.g., EHR, EMR, etc.). The data can be sent via the cloud- and/or other server-based platform, for example.

At block 470, the patient monitoring data can be processed. For example, the data being transmitted from the PHR to the EHR/EMR can be processed based on one or more rules, analytics, etc., provided via the cloud- and/or other server-based infrastructure connecting the PHR to the EMR/EHR. One or more trends, alerts, reports., etc., can be provided based on the patient monitoring data.

At block 480, the patient monitoring data is received at the provider's clinical information system (e.g., EHR, EMR, etc.). The data can be received at the EMR/EHR in conjunction with one or more alerts, analytics, etc. For example, the analytics may determine that the patient monitoring data falls within acceptable limits. Alternatively, the analytics may determine that the patient monitoring data falls outside of acceptable threshold/limit and may trigger an alert, alarm, and/or request for more information to the provider (and/or the patient).

At block 490, output is provided to the provider and/or the patient. For example, an indication of data within limits, warning outside of limits, alarm, etc., can be provided to the provider and/or patient to inform, request additional information, trigger additional action, alter the prescription, etc.

FIG. 5 is a block diagram of an example processor platform 500 capable of executing the instructions of FIG. 4 to implement the example systems 100, 200 and/or dashboard interface 300 of FIGS. 1-3. The processor platform 500 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives.

The coded instructions 532 of FIG. 4 may be stored in the mass storage device 528, in the volatile memory 514, in the non-volatile memory 516, and/or on a removable tangible computer readable storage medium such as a CD or DVD.

Thus, certain examples facilitate collection of patient data according to an informational prescription in conjunction with one or more devices/applications that capture, format, and organize the collected patient data. One or more rules and/or alerts can be arranged to sit on top of a cloud-based intermediary platform to process the collected patient data being exchanged between the patient's record and the provider's record to, for example, send alerts to the patient and/or provider if data is not being sent/received, notify the patient and/or provider of readings outside an accepted or “normal” range, track trends in the data, etc. Analytics can also sit on top of the data “in the cloud” to determine how the patient and/or a group of similar patients (e.g., patients enrolled in a hypertension monitoring program) are doing (e.g., how many enrolled, how many providing data at an appropriate frequency, how are their outcomes, what is the cost of care, what's a population comparison for a number of hospitalizations, etc.). PRM associated with the data, analytics, rules, etc., can become a care management tool to provide education information, reminders, alerts, etc., in response to patient-submitted data. A dashboard (e.g., a patient-specific and/or population-based dashboard) can be provided to show adherence to care plan, comparisons, correlations, etc. Rather than simply viewing data through a portal, the patient-collected data (and associated analytics, alerts, etc.) are stored in patient and provider record systems such that the systems having the data can recognize it and take advantage of it. Patient engagement with their provider's plan of care is also enhanced.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A system, comprising:
a computer system including
a processor that runs computer readable instructions to generate and transmit, over a network, a health information prescription (iRx), wherein the iRx includes requirements including data type for patient data to be collected and frequency of receiving patient data; and
a patient application or device including a processor that runs computer readable instructions to
receive a transmitted iRx from the computer system;
collect patient data from a patient based on the data type requirement of the iRx;
transmit the patient data over a network to the computer system at the frequency required by the iRx;
wherein the computer system
receives the patient data transmitted from the patient application or device;
evaluates the patient data using a decision support engine to generate an appropriate action; and
outputs the appropriate action.

2. The system of claim 1, further comprising
a database storing a health record system that includes records for individual patients; and wherein a record for an individual patient includes a patient-submitted portion, a physician entered portion, and a provider entered portion.

3. The system of claim 1, wherein
the evaluation is a comparison of the patient data to normal ranges for a specific medical condition.

4. The system of claim 1, wherein
the appropriate action generated by the decision support engine is an acknowledgement to the patient if the patient data is within normal ranges for the specific medical condition.

5. The system of claim 1, wherein
the appropriate action generated by the decision support engine is an alert to a physician or care management team if the patient data is outside of normal ranges for the specific condition.

6. The system of claim 1, wherein
the appropriate action generated by the decision support engine is an automatic appointment scheduled if the patient data is outside normal ranges for the specific condition.

7. The system of claim 1, wherein
the decision support engine includes a rules engine that checks the values submitted within patient data to determine whether the values fall into defined normal ranges.

8. The system of claim 1, wherein
the appropriate action generated by the decision support engine is an automated reminder to the patient or provider if the patent data is not received at the prescribed frequency.

9. The system of claim 1, wherein
the patient application or device includes a user interface that allows a patient to view a label associated with an iRx; and said label shows what data a physician would like to them to provide and at what frequency.

10. The system of claim 1, wherein
the data type for patient data is associated with a specific medical condition.

11. The system of claim 1, wherein
the patient data is transmitted to the computer system via a standards-based interface.

12. The system of claim 1, wherein
the appropriate action generated by the decision support engine is an alert to the patient asking if help is needed or wanted, if the patient data is outside normal ranges for the specific condition.

13. The system of claim 1, wherein
the appropriate action generated by the decision support engine is an update to an analytics dashboard displayed on a user interface.

14. The system of claim 1, wherein
the appropriate action generated by the decision support engine is an update to trend data for the patient.

15. The system of claim 1, wherein
the appropriate action generated by the decision support engine is altering the iRx data type or frequency requirements.

16. The system of claim 1, wherein
the application or device stores the patient data in a personal health record for the patient.

17. The system of claim 1, wherein the computer system further comprises
a database that stores an electronic health records for a plurality of patients; and wherein the computer system stores the received patient data in an electronic health record associated with the patient.

18. The system of claim 1, wherein
the patient application or device automatically collects the patient data without explicit patient action.

19. The system of claim 1, wherein
the patient application or device collects patient data via a sensor or user interface.

20. The system of claim 19, wherein
the patient application or device can receive patient data via voiced-based data acquisition.
